(19) United States
(12) Patent Application Publication
(10) Pub. No.: US 2009/0093974 A1
(43) Pub. Date: Apr. 9, 2009

(54) Machine-Independent Roller Counting System

(76) Inventors: James Glass, Bollingbrook, IL (US); Josh Rieder, Mundelein, IL (US)

Correspondence Address: IP FOCUS LAW GROUP, LTD, 608 NORTH CARLYLE LANE, SUITE 100, ARLINGTON HEIGHTS, IL, 60004, US

(21) Appl. No.: 11/867,265

(22) Filed: Oct. 4, 2007

(51) Int. Cl. B26F 1/44; B26F 1/38; B26D 1/12; G06F 19/00

(52) U.S. Cl. 702/34; 83/663

(57) ABSTRACT

Roller cutting die comprises a body with substantially cylindrical outer surface defining a cutting pattern extending outwardly from the surface and a recess. Secured within the recess is a data recorder sensor module adapted to count rotations past the anvil roller. The sensor module includes an electromagnetic proximity sensor for generating a signal responsive to passage near the anvil roller, a processor coupled to the proximity sensor, a power use manager at least partially defined by the processor and the proximity sensor, and a power source for the processor and the sensor. A count of rotations is stored in a substantially non-volatile memory coupled to the processor.

### FIELD OF THE INVENTION

The present disclosure is generally directed to roller based machines and methods, and more particularly to engraved roller cutting dies.

### BACKGROUND OF THE INVENTION

Rotary (or roller) die cutting subsystems are typically a down stream part of what is called a rotary press structure, a number of versions of which are widely available. A rotary cutting die is typically a rigid cylindrical body having a cutting blade of a fixed pattern that protrudes outwardly to a uniform distance from the cylindrical circumference. The ultimate edge of the blade pattern either contacts or nearly contacts an adjacent anvil roller, which is typically a smooth, hard, metallic cylinder. The system includes mechanisms for driving the roller die and anvil synchronously, and a structural restraint or frame portion. The sheet material intended to be cut into the pattern defined by the blade passes between the roller cutting die and the anvil. Though individual, pre-cut sheets of material can be fed through a rotary die, it is more common to cut material including foam parts in continuous form (defined in the industry as a web). The terms “sheet material” or “web material” as used herein are intended to encompass continuous and discontinuous stock, such as the different webs, strips and bands used in die culling operations, whether they are in single or multiple layers, and also whether they are of paper, plastic or other materials.

When the sheet material is to be cut entirely through in what is called “zero tolerance” cutting, the ultimate edges of the blade pattern must lightly contact or be very slightly spaced from the anvil roller. Alternatively, a common application of rotary cutting dies is cutting labels from a continuous web of label stock, in which not all layers of the web material are to be cut. Label stock consists of one or more layers of label material which may be printed, a coating of pressure-sensitive adhesive, and a carrier or backing layer which is coated with a release coating permitting it to be peeled away from the adhesive coated label material. Hence, for label cutting, only an adhesive backed surface layer on a laminate is to be cut while the underlying substrate remains uncut, sometimes referred to as “kiss cutting.”

Most of the conventional label stock materials used are in the range of a few hundredths of an inch to a few thousandths of an inch in thickness. In practice it is usually found that the needed spacing (or “clearance”) between the ultimate edge of the cutting blade must be maintained to within a few ten thousandths of an inch. This tolerance must be maintained under actual operating conditions which involve wear, heat expansion and high reactive forces.

Although there are various rotary die systems that rely on replaceable cutting elements removably attached to the die cylinder, more demanding applications rely on engraved, solid cutting dies. Engraved cutting die are precisely formed, hardened cylindrical bodies, and the cutting blade patterns are usually hard, precision finished at the ultimate edge, and, at least initially, of uniform height and profiles. Engraved rotary dies are comparatively more expensive and a different cylinder is required for each cutting label pattern. Die blades are susceptible to damage and wear and in normal conditions, are repeatedly resharpened. Engraved cutting dies may be coated or plated with wear resistant alloys before resharpening the blade patterns.

The ends of the cutting die and anvil roller are set in bearing blocks held in a structural restraint or frame portion that provide some restraint. Precision for the clearance maintained between rollers is provided by opposing bearing surfaces, called “bearers,” at or near the ends of their cylindrical bodies. The bearers on the cutting die are in contact with the anvil, and the anvil often is supported on the opposite side from the roller die by a back-up support roller. A planner selects the radial dimensions of the bearers on the roller die and anvil for a given application, to provide a chosen nominal blade-anvil clearance for the material that is to be cut. Further, minor adjustments are made by the use of preloading or compressive forces acting on the journals or bearers. Compression of the bearers displaces the blade tips of the roller die slightly but measurably, and reduces the clearance by a determinable amount.

The effective clearance changes during operation because of thermal expansion (from cold start) and blade wear. Wear rates on the blades of the cutting pattern are dependent upon the nature of the sheet material and the amount of preloading used. Increased preloading is used in response to blade wear until it is determined that the cutting die must be resharpened or replaced. The use of higher loading forces is known to increase wear and reduce overall die life.

Efficient press operating companies maintain multiple press lines and strive for job flexibility, high volume capability and just-in time delivery to customers. Maintenance of cutting die inventories and the related task of scheduling die reprocessing are significant challenges for press operators. For example, a culling die needed for an infrequently run printing job may be drawn from storage and found to be too dull to complete the run. Even a rushed resharpening of the cutting dies which is usually provided by third-parties, may not allow the press operator to meet a shipment deadline. In addition, wear based failure of a cutting die during a run can result in significant lost material. To address this die-cutter wear uncertainty, operators may require extended order lead-times or more frequently reprocess dies well before resharpening is actually required—sacrificing useful blade material. Both of these approaches reduce overall efficiency.

Efforts for tracking die wear based on usage are reflected in manual systems in which press operators record a measure of past usage on die containers before returning the die to storage. These manual systems are generally unreliable, however. Press operators often fail altogether to record usage data, and when such information is recorded, the data format varies according to operator preference and press controller electronics. For example, some automated presses may report usage in feet of web material processed while others report the number of die rotations. Conventional press automation and data tracking schemes are machine dependent, and therefore, vary according to equipment age and manufacturer. Press operating companies generally maintain a wide variety of press equipment, some of which may offer no measure of cutting die usage.

A need exists for improved wear tracking of rotary cutting die that is independent of press equipment controls and operator discretion.

### SUMMARY OF THE INVENTION

Roller cutting dies according to this invention comprise a body with substantially cylindrical outer surface defining a cutting pattern extending outwardly from the surface and a recess. Secured within the recess is a data recorder sensor module adapted to count rotations past the anvil roller. The sensor module includes an electromagnetic proximity sensor for generating a signal responsive to passage near the anvil roller, a processor coupled to the proximity sensor, a power use manager at least partially defined by the processor and the proximity sensor, and a power source for the processor and the sensor. A count of rotations is stored in a substantially non-volatile memory coupled to the processor.

The non-volatile memory and the processor are preferably resident on a single microcontroller semiconductor integrated circuit. The power use manager operates the processor in a high consumption state when the sensor passes near the anvil roller but resets to a substantially zero power consumption prior to and subsequent to detection of the anvil roller.

The sensor module includes a data communication interface coupled to the processor which optionally takes the form of a physical connection, a radio frequency link or a coded optical link. The interface is preferably two way, serving for delivery and then display of rotation count data and also initial programming of the microcontroller,

A method aspect of the present invention concerns the use of a rotary cutting die including a recorder sensor module free from any physical interconnections with any exterior subsystems but configured to count of the cutting die. The method provides a process for monitoring the wear of a rotary cutting die used in cooperation with an anvil roller for pattern cutting of a web of material and comprises providing a rotary cutting die including a self-contained proximity sensor module, processing web material with the rotary cutting die, counting and incrementally recording each rotation of the rotary cutting die with the sensor module to provide a rotation count, measuring wear of the blade pattern and associating the rotation count with the wear measurement to provide a wear-rotation count data set, and repeating the above steps until a first predetermined blade wear level is measured to populate a wear versus rotation-count data table. Finally, the data table is used to estimate a rotation count target for a maximum in-use blade wear level.

Other advantages and features of the present invention will be more readily apparent from the following detailed description of the preferred embodiments of the invention, the accompanying drawings, and the appended claims.

### BRIEF DESCRIPTION OF THE DRAWINGS

FIG. 1 is a side elevation view of cooperating cutting and anvil cylinders of a rotary die cutting apparatus according to this invention;

FIG. 2 is a side elevation view of the cutting and anvil cylinders of FIG. 1 partially rotated;

FIG. 3 is a cross-sectional view of the cutting die and anvil cylinder with a web shown disposed therebetween, as taken along plane 3-3 of FIG. 1;

FIG. 4 is a block diagram illustrating major elements of a data recorder sensor module according to this invention;

FIG. 5 is a schematic diagram showing how a sensor module is removably secured to a rotary die according to the present invention; and

FIG. 6 is a schematic diagram illustrating an alternate approach for securing a sensor module to a rotary die using adhesive.

### DETAILED DESCRIPTION OF THE INVENTION

The invention disclosed herein is, of course, susceptible of embodiment in many different forms. Shown in the drawings and described here in detail are preferred embodiments of the invention. It is to be understood, however, that the present disclosure is an exemplification of the principles of the invention and does not limit the invention to the illustrated embodiments.

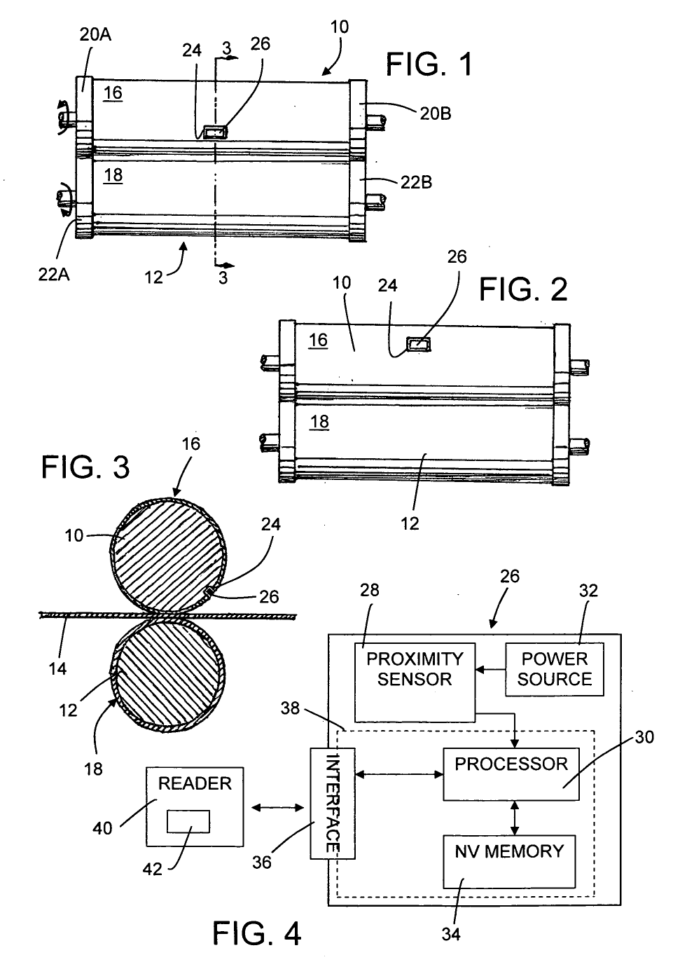

Turning now to the drawings wherein common reference numbers refer to like and corresponding elements throughout the several diagrams, a rotary cutting apparatus is shown in FIGS. 1 through 3 including a rotary cutting die 10 and an anvil roller 12. Cutting die 10 and anvil roller 12 are each mounted for rotation about their respective longitudinal axes and cooperating with one another for the die cutting of a web 14 passing therebetween. Cutting die 10 has a die cutting surface 16 thereon either spaced from or in interference with anvil surface 18. The clearance between die cutting surface 16 and anvil surface 18 is established in part by the diameter size of the cylinders and the bearer extensions 20A, 20B provided at opposite ends of cutting cylinder 10, and similar bearer extensions 22A, 22B at opposite ends of anvil cylinder 12.

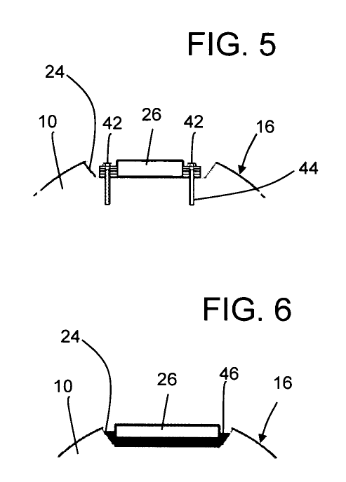

Cutting die 10 includes a recess 24 from cutting surface 16 for receiving a sensor module 26 that is configured to count and record rotations past anvil roller 12. Sensor module 26 is preferably secured to cylinder 10 with fasteners 42 (e.g., bolts or screws) received within holes 44 in recess 24 formed by drilling or taping as shown schematically in FIG. 5. The threads of the fasteners are preferably coated with an adhesive such as the anaerobic adhesive commercially available under the designation “Locktite” from the Henkel Locktite Corporation (Hartford, Conn.). Alternate approaches to securing sensor module 26 within recess 24 are contemplated including heat-resistant potting adhesive 46 as shown schematically in FIG. 6.

Referring to FIG. 4, an overall block diagram of sensor module, generally designated 26, in accordance with this invention is shown. In FIG. 4, a single block or cell may indicate several individual components and/or circuits that collectively perform a single function. Likewise, a single line may represent several individual signals or energy transmission paths for performing a particular operation. Recorder 26 includes a housing and an electromagnetic proximity sensor 28 for generating a signal responsive to passage near anvil roller 12. Sensor 28 is operably coupled to a processor 30 and a power source 32. Processor 30 is connected for two-way communication with both a nonvolatile memory 34 such as a flash memory and a communication interface 36. Processor 30 is configured to count “up voltage” signals from sensor 28, increment and store counts representative of sensor module 26 rotations past anvil roller 12, and communicate data recorded in and otherwise manage memory 34.

Sensor 28 preferably comprises a magnetic sensing device to take advantage of conventional anvil rollers (such as roller 12) which are made of magnetically attracted material such as steels and related iron alloys. As used herein, the terms “magnetic proximity sensor” or “magnetic sensing device” are a reference to sensors which rely on magnetic attraction and are responsive to the proximity of an object containing magnetically attracted material. As discussed further r below, to provide a power-saving feature, sensor 28 preferably rests in an open circuit position and is responsive to the close presence of anvil roller 12 by closing a circuit, i.e., making a connection.

As such, preferred magnetic sensors rely on a normally open reed switch or equivalent. The contacts of the reed switch are held normally open by a magnetic field of one or more permanent magnets. When a magnetically attractive object is within sensing range, the magnetic field is substantially neutralized, thereby closing the contacts of the reed switch. When the object is removed beyond the sensing distance, the strength of the magnetic field acting on the reed switch is restored and the contacts of the reed switch open. A preferred magnetic sensor is available in the form of a sealed integrated unit from IDEC Corporation (Sunnyvale, Calif.) under the designation “DPRI.”

Sensor 28 preferably has a reset speed of at least 30 cycles per second, i.e. can detect at least 1800 rotations past anvil per minute, and more preferably a reset speed of at least 50 cycles per second. Processor 30 is likewise selected and configured to accommodate such cycle speeds.

Processor 30 and non-volatile memory 34 are preferably integrated into a single microcontroller semiconductor chip, identified in FIG. 4 as an outline with reference number 38. A suitable semiconductor integrated circuit is a CMOS based microcontroller with flash memory commercially available from Microchip Technology, Inc. sold under the designation “16F675.”

Processor 30 and sensor 28 together are configured to define a power manager for extending battery life when stationary or during storage. Processor 30 is configured to “turn off” in the absence of rotation. More specifically, the power use manager operates the processor in a high consumption state when the sensor 28 detects rotation past anvil roller 12 (a predetermined event) at least at least once every ten milliseconds and more preferably at least once every five milliseconds. Prior to and subsequent to detection of rotation via sensor 28, the power use manager operates the processor in a low consumption state, which is substantially no power consumption.

Power source 32 preferably takes the form of an extended life battery such as 3 volt lithium ion cell sold under the designation BR1225. In an alternate embodiment, power source 32 includes an inertial micro-scale generator driven by vibration or rotational energy available as die 10 is rotated. Such an energy scavenging generator extends storage life for the sensor function. For a further discussion of micro-scale power generators applicable to this invention see the following references, the disclosures of which are incorporated herein by reference: Roundy et al. Micro-electrostatic vibration-to-electricity converters. ASME International Mechanical Engineering Congress & Exposition, Nov. 17-22, 2002; C. Shearwood et al. Development of an eletromagnetic microgenerator, Electronics Letters, 33(22):1883-1884, Oct. 23, 1997; Meninger et al. Vibration-to-electric energy conversion. IEEE Transactions On Very Large Scale Integration (VLSI) Systems, 9(1):64-76, February 2001; Amirtharajah et al. Self-powered signal processing using vibration-based power generation, IEEE Journal of Solid-State Circuits, 33(5):687-695, May 1998.

Data communication interface 36 allows for reading memory 34 including a count of rotations and programming controller 38 and is adapted for communication with a reader 40. In the preferred embodiment, reader 40 is adapted for communication with microcontroller 38 according to the predetermined electronic protocols. The user connection to interface 36 is preferably selected from the group consisting of a physical connection, a radio frequency link and a coded optical link. A physical connection is preferred for lower fabrication costs but, depending upon the overall layout of module 26 and recess 24, may require removal of module 26 from recess 14 to make the physical interconnection to reader 40. Wireless connections via radio-frequency or infrared are preferred for ease-of-use but generally involve more costly fabrication of both module 26 and reader 40. Likewise, such non-contacting connections generally require relatively more space.

Rotary cutting dies according to the present invention include a sensor module that is relatively compact and can be installed in a relatively small recess from the cylinder surface. For example, a sensor module 26 according to FIGS. 1 through 4 preferably occupies a substantially parallelepiped space of no larger than about 20 cubic centimeters, and more preferably no larger than 15 cubic centimeters. Also significant is overall footprint, which for module 26 is preferably substantially square or rectangular and no larger than about 10 square centimeters, and more preferably no larger than 7.5 square centimeters.

A key feature of the present invention is extended shelf-life. Roller dies according to this invention include substantially permanent data storage and no quiescent power draw. A further feature of this invention is press system independence. Die rollers according to this invention are self contained and rely only upon the presence of a conventional anvil roller rather than a particular mechanical setup or specific press control configuration.

A further feature of the present invention is improved wear prediction and therefore better die usage control. Rotary cutting dies according to the present invention are used to compile wear versus rotation-count data sets. Thereafter, when the same die or similar dies are used the number of rotation can be monitored and dies taken out for refurbishing (sharpening) at the appropriate time as indicated by the wear versus rotation data sets. In one approach, the data set includes rotation versus wear data measured until a die is confirmed to require refurbishing. In an alternate approach, the data set generated is partial such that count versus wear data is available for a smaller range of wear measurements and the count at which the die requires refurbishing is extrapolated from the data collected.

Numerous variations and modifications of the embodiments described above may be effected without departing from the spirit and scope of the novel features of the invention. No limitations with respect to the specific system illustrated herein are intended or should be inferred. It is, of course, intended to cover by the appended claims all such modifications as fall within the scope of the claims.

What is claimed is:

1. A rotary cutting die suitable for use in proximity to an anvil roller, the die comprising:
a body with substantially cylindrical outer surface defining a cutting pattern extending outwardly from the surface and a recess; and
a sensor module secured within the recess and adapted to count rotations past the anvil roller, the sensor module includes an electromagnetic proximity sensor for generating a signal responsive to passage near the anvil roller, a processor coupled to the proximity sensor, a power use manager at least partially defined by the processor and the proximity sensor, and a power source for the processor and the sensor.

2. The rotary die of claim 1 wherein the proximity sensor has a reset speed of at least 30 cycles per second.

3. The rotary die of claim 1 further comprising a substantially non-volatile memory coupled to the processor for storing rotations data.

4. The rotary die of claim 3 wherein the non-volatile memory and the processor are resident on a single integrated circuit semiconductor chip.

5. The rotary die of claim 3 wherein the non-volatile memory is a flash memory.

6. The rotary die of claim 1 wherein the power use manager operates the processor in a high consumption state while a predetermined event is detected.

7. The rotary die of claim 6 wherein the power use manager operates the processor in a low consumption state, compared to the high consumption state, prior to and subsequent to detection of the predetermined event.

8. The rotary die of claim 7 wherein the low consumption state is substantially no power consumption.

9. The rotary die of claim 1 wherein the sensor module further comprises a data communication interface coupled to the processor.

10. The rotary die of claim 1 wherein the data communication interface provides a user connection selected from the group consisting of a physical connection, a radio frequency link and a coded optical link.

11. The rotary die of claim 1 wherein the sensor module is removably secured in the recess.

12. The rotary die of claim 1 wherein the proximity sensor includes a reed switch.

13. The rotary die of claim 12 wherein the reed switch is movable to a closed circuit state when near the anvil roller and resets to an open circuit state.

14. A rotary cutting die suitable for use in proximity to an anvil roller, the die comprising:
a body with substantially cylindrical outer surface defining a cutting pattern extending outwardly from the surface and a recess; and
a data recorder secured within the recess and adapted to count rotations past the anvil roller, the recorder including a proximity sensor for generating a signal responsive to the sensor's passage near the anvil roller, a processor coupled to the proximity sensor and a power source, wherein the proximity sensor includes a proximity detection switch coupled to the power source and the switch is movable to a closed circuit state when positioned within a predefined distance from the anvil roller and resets to an open circuit state when farther from the anvil roller than the predefined distance.

15. The rotary die of claim 14 wherein the power source includes a microscale inertial generator.

16. A process for monitoring the wear of a rotary cutting die used in cooperation with an anvil roller for pattern cutting of a web of material, the process comprising:
(1) providing a rotary cutting die having a cylindrical cutting surface defining a recessed receptacle and blade pattern, the rotary cutting die including a self-contained proximity sensor module received in the recess for counting rotations past the anvil roller;
(2) processing web material with the rotary cutting die,
(3) counting and incrementally recording each rotation of the rotary cutting die with the sensor module to provide a rotation count;
(4) measuring wear of the blade pattern and associating the rotation count with the wear measurement to provide a wear-rotation count data set;
(5) repeating steps (1) through (4) until a first predetermined blade wear level is measured to populate a wear versus rotation-count data table; and
(6) estimating a rotation count target for a maximum in-use blade wear level from the rotations-count data table.
